(19) United States
(12) Patent Application Publication
(10) Pub. No.: US 2020/0394628 A1
(43) Pub. Date: Dec. 17, 2020

(54) STORE CLERK CALL SYSTEM AND STORE CLERK CALL PROCESSING METHOD

(71) Applicant: TOSHIBA TEC KABUSHIKI KAISHA, Tokyo (JP)

(72) Inventor: Yuya URANAKA, Izunokuni Shizuoka (JP)

(21) Appl. No.: 16/747,680

(22) Filed: Jan. 21, 2020

(30) Foreign Application Priority Data
Jun. 12, 2019 (JP) 2019-109452
Sep. 20, 2019 (JP) 2019-171641

(51) Int. Cl. G06Q 20/18; G08B 5/22

(52) U.S. Cl. CPC G06Q 20/18; G08B 5/226

(57) ABSTRACT

A store clerk call system includes a self-service terminal, a plurality of information terminals, and a store controller. The self-service terminal is configured to perform checkout processing and generate a call-out signal upon receiving a call-out request input from a user. The store controller is configured to receive the call-out signal from the self-service terminal. Upon receiving the call-out signal, the store controller selects at least one information terminal that meets a predetermined condition from the plurality of information terminals. The store controller then transmits an attendance request to the selected information terminal(s). The attendance request causes the selected information terminal to generate a call-out notification.

### CROSS-REFERENCE TO RELATED APPLICATIONS

This application is based upon and claims the benefit of priority from Japanese Patent Application No. 2019-109452, filed on Jun. 12, 2019, and Japanese Patent Application No. 2019-171641, filed on Sep. 20, 2019, the entire contents of which are incorporated herein by reference.

### FIELD

Embodiments described herein relate generally to a store clerk call system and a store clerk call processing method for stores with self-service kiosks or the like.

### BACKGROUND

In a retail store, such as a supermarket, a self-service checkout terminal or kiosk at which a customer performs various operations associated with a sales transaction (commodity sales data processing) by himself or herself has been introduced in response to possible labor shortages. Such a self-service checkout terminal may also be called a self-service register, a self-service kiosk, or a self-service point-of-sales terminal as well.

The self-service register has a function of calling or hailing a store clerk to request support associated with customer operation of the self-service register. For example, if a customer presses a store clerk calling button of a self-service register, a lamp of the self-service register flashes or a call-out notification is displayed on an attendant station. Consequently, it is possible to support the customer.

However, in an eating place, a restaurant, or the like, an attendant (e.g., a waiter or service person) with responsibility for attending to a customer may not always be assigned to an attendant station or otherwise continuously at such a station. There is also a store system that does not at all include a fixed attendant station. Therefore, attending to a customer requesting help at a self-service register in such a system may be delayed because there is no dedicated attendant station for such handling such requests.

### DESCRIPTION OF THE DRAWINGS

FIG. 1 is a schematic diagram illustrating a configuration example of a store system in an embodiment.

FIG. 2 is a diagram illustrating a hardware configuration of a store system.

FIG. 3 is a diagram illustrating a data table of store clerk information.

FIG. 4 is a flowchart illustrating store clerk call-out processing method according to an embodiment.

FIGS. 5A and 5B are display examples of a “call-out notification” displayed on a hand-held terminal. FIG. 5A illustrates the hand-held terminal in an idle state. FIG. 5B illustrates the hand-held terminal in a non-idle state.

FIG. 6A is another display example of the “call-out notification” displayed on the hand-held terminal.

FIG. 6B is a display example of “call-out termination notification” displayed on the hand-held terminal.

### DETAILED DESCRIPTION

Embodiments provide an on-site attendant service providing system and method that can achieve quick customer attendance.

A store clerk call system includes a self-service terminal, a plurality of clerk information terminals, and a store controller. The self-service terminal is configured to perform checkout processing and generate a call-out signal upon receiving a call-out request (help request) from a user (e.g., customer). The store controller is configured to receive the call-out signal from the self-service terminal. Upon receiving the call-out signal, the store controller selects at least one information terminal that meets a predetermined condition from the plurality of information terminals. The store controller then transmits an attendance request to the selected information terminal. The attendance request causes the selected information terminal to generate a call-out notification which can be viewed by or otherwise ascertained by a store clerk.

In the store system according to the embodiment, the store controller may select, based on position information of the self-service checkout terminal that receives the store clerk call-out request and the mobile terminal, the store clerk capable of dealing with the store clerk call-out request.

A store clerk call-out processing method in another embodiment includes: a self-service checkout terminal receiving a store clerk call-out request; a store controller selecting, if receiving a store clerk call-out signal, which may be referred to as a call-out signal, from the self-service checkout terminal, based on store clerk information, a store clerk capable of dealing with the store clerk call-out request and outputting call-out information to the mobile terminal carried by the store clerk; and the mobile terminal displaying a call-out notification if receiving the call-out information.

A store system, a store clerk call-out processing method, and software in example embodiments are explained below with reference to the drawings. In the drawings, the same components are denoted by the same reference numerals and signs.

Store System

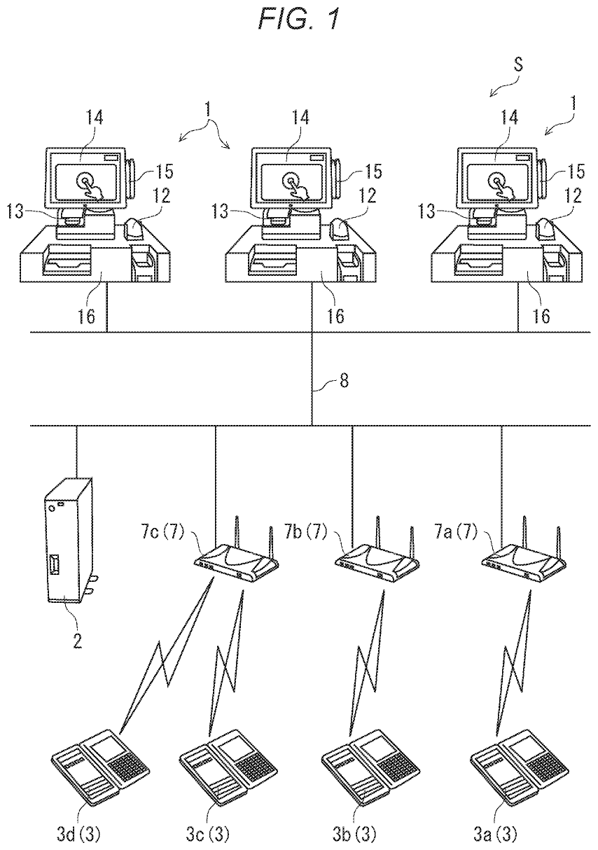

FIG. 1 is a schematic diagram illustrating a configuration example of a store system S according to the embodiment.

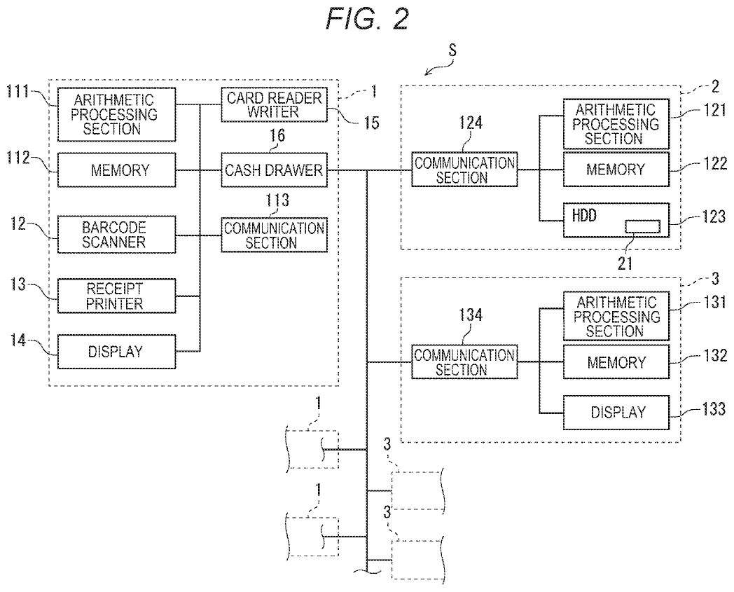

FIG. 2 is a diagram illustrating a main hardware configuration of the store system S.

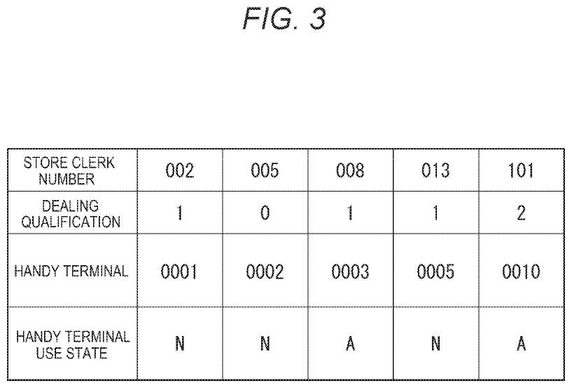

FIG. 3 is a diagram illustrating a data table of store clerk information.

The store system S is a system used for ordering and accounting (settlement processing) for foods, beverages, or other menu items at an eating place such as a restaurant.

The store system S includes self-service checkout terminals 1 (also referred to more generally as self-service terminal), a store controller 2, and wireless communication units 7, which are connected via a communication line 8 such as a wired LAN. Hand-held (“handy”) terminals 3 are connected to the wireless communication units 7 by wireless communication.

The number of the self-service checkout terminals 1, the wireless communication units 7, and the handy terminals 3 can be varied and/or variable.

The self-service checkout terminal 1 is a terminal for a customer to perform various kinds of operation for executing commodity sales data processing and checkout processing. Specifically, the self-service checkout terminal 1 reads a barcode printed on an accounting slip and performs settlement of the accounting slip.

That is, information input to the self-service checkout terminal 1, for example by a user, is transmitted to the store controller 2. Accounting information and the like recorded in the store controller 2 are transmitted to the self-service checkout terminal 1.

The self-service checkout terminal 1 includes a barcode scanner 12, a receipt printer 13, a display 14, a card reader writer 15, and a cash drawer 16. Further, the self-service checkout terminal 1 includes an arithmetic processing section 111, a memory 112, and a communication section 113.

The cash drawer 16 is disposed at the lower end of the self-service checkout terminal 1. The barcode scanner 12 and the receipt printer 13 are disposed above the cash drawer 16. Further, the display 14 is disposed above the receipt printer 13. The card reader writer 15 is provided on the right side of the display 14.

The barcode scanner 12 reads a barcode printed on an accounting slip.

The receipt printer 13 prints a receipt and discharges the receipt to a customer.

The display 14 displays names, prices, images, and the like of commodities (e.g., foods, beverages, other items) being registered for sale to the customer.

The card reader writer 15 reads data from and writes data to a credit card or the like.

The cash drawer 16 performs handling of coins and bills.

Further, a speaker that emits warning sound and voice guidance and an LED display lamp that displays a present state of the self-service checkout terminal 1 can be provided in the self-service checkout terminal 1. The LED display lamp emits light in, for example, blue or red.

The display 14 is a so-called touch panel display. The customer can perform various kinds of input operations associated with registration processing such as accounting/settlement processing by himself or herself on the display 14.

For example, when the customer touches the display 14 and begins to operate the self-service checkout terminal 1, a “store clerk call-out request button” can be displayed on the display 14. The store clerk call-out request button is used to call a store clerk if the customer has difficulty in an operation at the self-service checkout terminal 1 or if a trouble occurs. If the customer presses (touches) the store clerk call-out request button, a store clerk call-out signal is output to the store controller 2. At the same time, guidance indicating that a store clerk is being called is displayed on the display 14 or emitted from a speaker. In addition, the LED display lamp emits a red light.

The store controller 2 is a computer that stores information such as article/product names, prices, stock states (inventory counts), sales histories, and records of receiving and making payments of commodities provided to customers at the store. The store controller 2 includes an arithmetic processing section 121, a memory 122, a hard disk 123, and a communication section 124.

The information described above is aggregated and various computer programs are stored in the hard disk 123 of the store controller 2. Consequently, the store controller 2 aggregates information input from the self-service checkout terminal 1 and the handy terminal 3 and transmits various kinds of information to the self-service checkout terminal 1 and the handy terminal 3. The store controller 2 may be referred to as a control terminal.

For example, the arithmetic processing section 121 of the store controller 2 receives a store clerk call-out signal from a self-service checkout terminal 1. The store controller 2 selects a store clerk capable of dealing with the store clerk call-out request and outputs call-out information to the handy terminal 3 carried by that store clerk.

Store clerks capable of dealing with the store clerk call-out request are registered (stored) in advance in the hard disk 123 as store clerk information 21. The arithmetic processing section 121 selects a store clerk by determining whether the store clerks satisfy a predetermined condition.

As illustrated in FIG. 3, the store clerk information 21 includes store clerk numbers (e.g., employee ID numbers), sales-level qualifications (“dealing qualification information”), handy terminal numbers (terminal ID numbers), and handy terminal use states.

The dealing qualification information indicates whether a store clerk is qualified to deal with the store clerk call-out request. In this information a value of “0” means that the store clerk does not have the appropriate dealing qualification and values of “1” or “2” mean that the store clerk is qualified to deal with the call-out request.

For example, a part-time store clerk or a newly hired store clerk unaccustomed to the operation of the self-service checkout terminal 1 would correspond to “0”. A standard store clerk corresponds to “1” and an administrator level employee, such as a store manager, corresponds to “2”. Here, a “1” value has a higher call-out priority degree than a “2” value. The call-out priority degree values are further explained below.

The handy terminal use state indicates whether the handy terminal 3 is being operated. Here, “A” means the terminal is in use and “N” means the terminal is in standby mode or the like.

In this way, a program for causing the store controller 2 to function as a store-clerk-call-out-request-signal receiving section, a store-clerk selecting section, and a call-out-information output section is stored in the memory 122 of the store controller 2. That is, the program causes the store controller 2 to function as the store-clerk-call-out-request-signal receiving section configured to receive a store clerk call-out signal output from the self-service checkout terminal 1, the store-clerk selecting section configured to select a store clerk capable of dealing with a store clerk call-out request if receiving the store clerk call-out signal, and the call-out-information output section configured to output call-out information to a mobile terminal (in this context, a handy terminal 3, for example) carried by the store clerk.

The wireless communication unit 7 is set on a ceiling or the like of the store and performs wireless communication with each handy terminal 3.

The handy terminal 3 is generally a small information processing terminal carried around by each of store clerks. The handy terminal 3 includes an arithmetic processing section 131, a memory 132, a display 133, and a communication section 134.

The display 133 is a so-called touch panel display and can display a message. A store clerk can perform various kinds of operations via the display 133.

Order information, such as an ordered article identifier and an ordered quantity can be input to the handy terminal 3. The information input to the handy terminal 3 is transmitted to the store controller 2.

The handy terminal 3 receives various kinds of information from the store controller 2. For example, the handy terminal 3 receives call-out information from the store controller 2. When receiving the call-out information, the handy terminal 3 displays the information on the display 133 or sounds an alarm to notify a store clerk call-out request to the store clerk.

Store Clerk Call-Out Processing Method

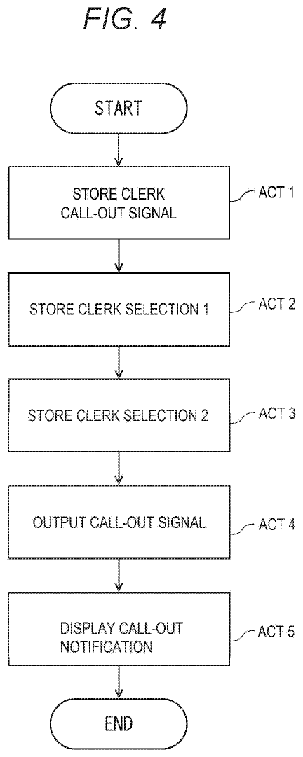

FIG. 4 is a flowchart illustrating a store clerk call-out processing method according to an embodiment.

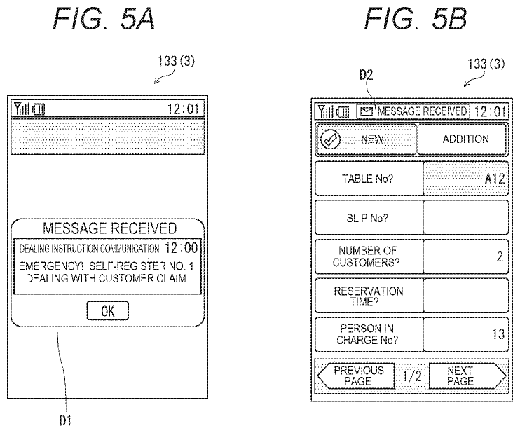

FIG. 5 is a display example of a “call-out notification” displayed on the handy terminal. FIG. 5A illustrates the handy terminal in an idle state. FIG. 5B illustrates the handy terminal in a non-idle state. FIG. 5B is a display example corresponding to the time at which a store clerk inputs order information at the store, for example, at a customer table in the store.

As explained above, when the customer operates the self-service checkout terminal 1, the “store clerk call-out request button” is displayed on the display 14.

The customer touches the “store clerk call-out request button” if the customer has difficulty in operation of the self-service checkout terminal 1 or if other trouble occurs. Then, the self-service checkout terminal 1 outputs a store clerk call-out signal to the store controller 2 (Act 1).

If a store clerk call-out signal from the self-service checkout terminal 1 is received, the store controller 2 selects a store clerk capable of dealing with the store clerk call-out request.

First, the store controller 2 identifies store clerks qualified to deal with the store clerk call-out request (Act 2).

For example, a part-time store clerk is excluded from those considered qualified. That is, the store controller 2 determines whether a store clerk is the store clerk having the necessarily qualification level for dealing with the store clerk call-out request. Whether or not a store clerk is a store clerk having an appropriate dealing qualification is determined by information registered in the hard disk 123 as a “dealing qualification” in the store clerk information 21.

In this example, the store controller 2 preferentially selects store clerks whose dealing qualification information value is set as “1”.

Subsequently, the store controller 2 selects, out of the store clerks having the appropriate dealing qualification, a store clerk who is not presently operating his/her handy terminal 3 (Act 3).

For example, when a store clerk is already inputting customer order information or the like to the handy terminal 3 (that is, the handy terminal 3 is in operation or a non-idle state), the such presently occupied store clerk presumably cannot immediately deal with the store clerk call-out request even if the store clerk has the appropriate dealing qualification.

Therefore, the store controller 2 selects a store clerk carrying a handy terminal 3 that is presently in the idle state.

Whether a store clerk is the store clerk carrying the handy terminal 3 in the idle state is registered in the hard disk 123 as a “handy terminal” and a “handy terminal use state” of the store clerk information 21.

The store controller 2 thus selects a store clerk whose handy terminal use state is “N”.

A plurality of store clerks may sometimes selected through Act 2 and Act 3. When the store clerk information 21 is as illustrated in FIG. 3, store clerks with store clerk numbers 002 and 0013 are both selected.

If, through Act 2 and Act 3, multiple store clerks are selected, then multiple store clerks may be caused to deal with the store clerk call-out request, the store controller outputs call-out information to the handy terminal 3 carried by each selected store clerk (Act 4).

As illustrated in FIG. 5A, upon receiving the call-out information, the handy terminal 3 displays the call-out information (a call-out notification) in a received message display field D1 of the display 133 and notifies an instruction for dealing with the store clerk call-out request to the store clerk (Act 5).

As illustrated in FIG. 5B, the store controller 2 may cause a handy terminal 3 in the non-idle state (here, for a store clerk having a store clerk number 008) to display a simple notification in a simple message display field D2 of the display 133.

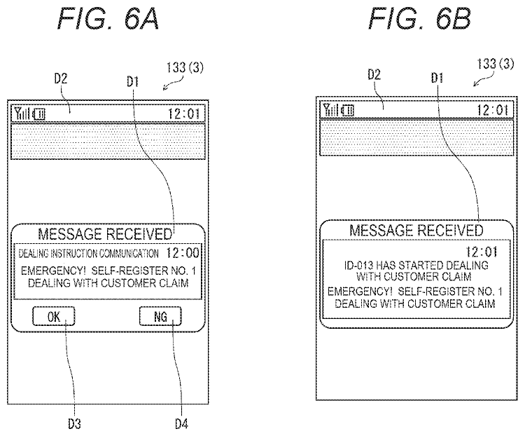

FIG. 6A is another display example of the “call-out notification” displayed on the handy terminal. FIG. 6B is a display example of “call-out termination notification” displayed on the handy terminal.

As illustrated in FIG. 6A, whether the store clerk can deal with the call-out notification (the store clerk call-out request) may be replied (confirmation returned) from the handy terminal 3 to the store controller 2.

For example, the call-out information is displayed in the received message display field D1 of the display 133 of the handy terminal 3 and, at the same time, an “OK” button D3 and an “NG” button D4 are displayed.

The “OK” button D3 is used to inform the other store clerks of a start of the clerk's customer attendance at the self-service checkout terminal 1 for which the store clerk call-out request was performed. The “NG” button D4 is used to inform the other store clerks that customer attendance by the clerk may be difficult at this time.

If the “OK” button D3 or the “NG” button D4 is selected, information concerning the selection (an attendance start signal or an attendance rejection signal) is transmitted to the store controller 2.

For example, if the store clerk with the store clerk number 013 among the store clerks who receive the call-out notification touches the “OK” button D3, the attendance start signal is transmitted to the store controller 2.

Subsequently, as illustrated in FIG. 6B, call-out termination notification is notified from the store controller 2 to all the store clerks. The call-out termination notification is information for ending the previous call-out notification and includes information (here, the store clerk number 013) of the store clerk who has started dealing with the store clerk call-out request (that is, will be providing the requested customer attendance).

Consequently, it is possible to eliminate unnecessary work of multiple store clerks going to the same self-service checkout terminal 1 for which the store clerk call-out request was performed.

If all of the store clerks who receive the call-out notification touch the “NG” button D4, all attendance rejection signals are notified to a store clerk) having dealing qualification information “2” (e.g. a responsible person such as the store manager). As a last resort customer attendant, the responsible person such as the store manager can go to the self-service checkout terminal 1 at which the store clerk call-out request was performed. The store clerk having a dealing qualification information “2” is often busy compared to a store clerk having dealing qualification information “1”. Therefore, a call-out priority degree is set higher for “1” value clerks than “2” value clerks to check first whether a store clerk having the dealing qualification information “1” can attend the customer. In this way, it is similarly also possible to preferentially select a person having a lower dealing qualification out of people having higher dealing qualifications.

Alternatively, if all of the store clerks who receive the call-out request touch the “NG” button D4, the store controller 2 may return to Act 2 and Act 3 and perform the store clerk selection again.

It is also possible to record information concerning a store clerk who dealt with store clerk call-out requests and use the information for the next store clerk call-out request. In selecting a store clerk who deals with the store clerk call-out request, the store controller 2 may refer to a store clerk call-out dealing record (history) and preferentially select, for example, a store clerk who has dealt with store clerk call-out requests only a small number of times in total.

In selecting a store clerk who deals with the store clerk call-out request, the store controller 2 may output the call-out information to those handy terminals 3 present in an area near to self-service checkout terminal 1 at which the store clerk call-out request was performed.

Setting position information (distances from the self-service checkout terminal 1) for the wireless communication units 7 can be stored in advance in the store controller 2. For example, wireless communication units 7a, 7b, and 7c are registered in ascending order of distances from the self-service checkout terminal 1.

When selecting a plurality of store clerks through Act 2 and Act 3, in Act 4, the store controller 2 can estimate time differences according to the order of the wireless communication units 7a, 7b, and 7c and output the call-out information to the handy terminals 3 according to these time differences.

Thus, if two store clerks carrying handy terminals 3a and 3c are selected through Act 2 and Act 3, the call-out information is first sent to the handy terminal 3a that is communicating with the wireless communication unit 7a. Then after, for example, thirty seconds, the call-out information is sent to the handy terminal 3c that is communicating with the wireless communication unit 7c.

Consequently, it is more likely that a store clerk present near the self-service checkout terminal 1 will be the one to perform customer attendance. It is thus possible to achieve quicker customer attendance.

In some examples, global positioning system receivers (GPSs) may be mounted on the handy terminals 3. The call-out information may be output to the handy terminals 3 (3a to 3d) in ascending order of distances from the self-service checkout terminal 1 based on GPS information from these GPSs.

As explained above, with the store system S and the store clerk call-out processing method according to the embodiment, it is possible to achieve quick customer attendance at the self-service register.

That is, the self-service checkout terminal 1 receives operation for call-out a store clerk. If receiving a store clerk call-out signal from the self-service checkout terminal 1, the store controller 2 selects a store clerk capable of dealing with a store clerk call-out request and outputs call-out information to the handy terminal 3 carried by the store clerk. If receiving the call-out information, the handy terminal 3 displays a call-out notification.

Since the store controller 2 selects the store clerk capable of dealing with the store clerk call-out request, it is possible to achieve quick and efficient customer attendance.

If receiving operation (pressing of the OK button) for informing a start of dealing with the store clerk call-out request, the handy terminal 3 outputs call-out termination notification to the remaining handy terminals 3. Consequently, it is possible to eliminate unnecessary work of a plurality of store clerks going to the self-service checkout terminal 1 at which the store clerk call-out request was performed.

The store controller 2 selects, based on position information of the self-service checkout terminal 1 originating the store clerk call-out request and the handy terminals 3, a store clerk capable of dealing with the store clerk call-out request. Consequently, it is possible to achieve quicker customer attendance.

The store system S according to the embodiment is not limited to that introduced into a restaurant or eating establishment and may also be introduced into a supermarket, a convenience store, a high-volume electronics retailer, or the like.

In the above explanation, in the store system S according to the embodiment, an information terminal that displays the store clerk call-out notification is a hand-held (“handy”) terminal 3. However, the information terminal is not limited to this and need not be a mobile or hand-held terminal in all instances. For example, in some store systems S, a kitchen display screen or a kitchen printer can be connected to communication line 8 or through a wireless communication unit 7. In such a store system S, an information terminal that displays the store clerk call-out notification may be the kitchen display screen or the kitchen printer rather than or in addition to a mobile or hand-held terminal. The store controller 2 may output the store clerk call-out notification to the kitchen display screen or the kitchen printer, which may be a fixed position in the store.

In example embodiments above, a store system without a dedicated attendant terminal was explained. However, in some embodiments, such an attendant terminal may be present or otherwise provided.

The attendant terminal in such case, can be a dedicated terminal, for example, operated by a store clerk specifically in charge of attending to customer requests for help/service at sales kiosks or the like. Such an attendant terminal may be a stationary type (e.g., substantially fixed in position) or may be a mobile type (e.g., a tablet type computer).

The store controller 2 may output the store clerk call-out notification to the attendant terminal as well other store clerk terminals.

In many scenarios, a store clerk specifically responsible for customer attendance may be absent (or it may be difficult for all the specifically responsible store clerks to perform the necessary customer attendance when attendance requests are at a high volume). In such a case, the store controller 2 may transmit the call-out information (including information indicating that the dedicated store clerk who can perform customer attendance is presently absent or otherwise unavailable) to all the handy terminals (store clerks) at the store. Thus, another store clerk capable of performing customer attendance goes to the self-service checkout terminal 1, and it is possible to minimize a time until the customer attendance request is handled.

In the explanation in the example embodiment, the store controller 2 selects a store clerk capable of dealing with the store clerk call-out request. However, there is no limitation thereto, and another computer that selects a store clerk may be provided. The handy terminals 3 may have the store clerk information 21 and thus determine whether a particular store clerk is a store clerk capable of dealing with a store clerk call-out request.

The embodiments are presented as examples and are not intended to limit the scope of the invention. These new embodiments can be carried out in other various forms. Various omissions, replacements, and changes can be made in a range not departing from the gist of the invention. These embodiments and modifications of the embodiments are included in the scope and the gist of the invention and included in the inventions described in the claims and the scope of equivalents of the inventions.

What is claimed is:

1. A store clerk call system, comprising:
a self-service terminal configured to perform checkout processing and generate a call-out signal upon receiving a call-out request input;
a store controller connected to the self-service terminal; and
a plurality of information terminals connected to the store controller, wherein
the store controller is configured to:
receive the call-out signal from the self-service terminal;
upon receiving the call-out signal, select an information terminal that meets a predetermined condition from the plurality of information terminals; and
transmit an attendance request to the selected information terminal, the attendance request causing the information terminal to generate a call-out notification.

2. The store clerk call system according to claim 1, wherein the predetermined condition includes a present operation state of the information terminal being an idle state.

3. The store clerk call system according to claim 1, wherein the plurality of information terminals includes a mobile terminal.

4. The store clerk call system according to claim 1, wherein
the plurality of information terminals are each a hand-held terminal respectively associated with different clerk IDs, and
the predetermined condition comprises a clerk ID associated with the information terminal being associated with a predetermined clerk authority level value.

5. The store clerk call system according to claim 1, wherein the predetermined condition includes a current location of the information terminal being within a predetermined area.

6. The store clerk call system according to claim 1, wherein each information terminal in the plurality of information terminals meeting the predetermined condition is selected, and the attendance request is transmitted to each selected information terminal.

7. The store clerk call system according to claim 6, wherein each of the information terminals is configured to provide an notification acceptance button.

8. The store clerk call system according to claim 1, further comprising:
a dedicated customer attendance terminal.

9. The store clerk call system according to claim 1, wherein at least one of the plurality of information terminals is a fixed terminal.

10. The store clerk call system according to claim 1, wherein at least one of the plurality of information terminals is a mobile terminal associated with a store clerk ID number.

11. A store clerk call processing method, comprising:
generating a call-out signal upon receiving a user call-out input operation at a self-service terminal;
receiving the call-out signal from the self-service terminal at a store controller;
upon receiving the call-out signal, selecting an information terminal from a plurality of information terminals based on a predetermined condition; and
transmitting an attendance request to the selected information terminal, the attendance request causing the information terminal to generate a call-out notification.

12. The method according to claim 11, wherein the predetermined condition is a present operation state of the information terminal being an idle state.

13. The method according to claim 11, wherein the plurality of information terminals includes a mobile terminal.

14. The method according to claim 11, wherein
the plurality of information terminals are each a hand-held terminal respectively associated with different store clerk IDs, and
the predetermined condition comprises a store clerk ID associated with the information terminal being associated with a predetermined clerk authority level value.

15. The method according to claim 11, wherein the predetermined condition includes a current location of the information terminal being within a predetermined area.

16. The method according to claim 11, wherein each information terminal in the plurality of information terminals meeting the predetermined condition is selected, and the attendance request is transmitted to each selected information terminal.

17. The method according to claim 16, wherein each of the information terminals is configured to provide an notification acceptance button.

18. The method according to claim 16, wherein at least one of the plurality of information terminals is a fixed terminal.

19. The method according to claim 16, at least one of the plurality of information terminals is a mobile terminal associated with a store clerk ID number.

20. The method according to claim 11, further comprising:
inputting a customer menu item order via at least one of the information terminals.
